(19) United States
(12) Patent Application Publication
(10) Pub. No.: US 2013/0039230 A1
(43) Pub. Date: Feb. 14, 2013

(54) Method and Device for Wireless Broadcast Power-up Sequence in Wireless Sensor Network

(71) Applicants: Jaesik Lee, Basking Ridge, NJ (US); Inseop Lee, Pittstown, NJ (US)

(72) Inventors: Jaesik Lee, Basking Ridge, NJ (US); Inseop Lee, Pittstown, NJ (US)

(21) Appl. No.: 13/569,053

(22) Filed: Aug. 7, 2012

Related U.S. Application Data
(60) Provisional application No. 61/521,412, filed on Aug. 9, 2011.

(51) Int. Cl. H04W 52/02; H04L 5/14

(52) U.S. Cl. 370/280; 370/311

(57) ABSTRACT

Method and device for smart power management of the sensor nodes within a wireless sensor network to achieve extremely low standby current and fast power-up time at the same time are provided. The method features a technique of centralized remote power-up scheme combined with local broadcasting power-up sequence to achieve fast power-up time and extended power-up coverage. It can manage the power-down sequence from a base-station to sensor nodes sequentially, while the power-up sequence broadcasts its power-up command from the base-station to all the sensor nodes within a sensor network. The device accepts same frequency band for both data communication and power-up message, and a RF switch separates receiving RF data and RF power-up message. The wireless power-up receiver is self-powered from power-up message and also generates power-up enable signal from it.

### RELATED APPLICATION

This application is a non-provisional application corresponding to Provisional U.S. Patent Application Ser. No. 61/521,412 for “Method and Device for Wireless Broadcast Power-up Sequence in Wireless Sensor Network” filed on Aug. 9, 2011.

### BACKGROUND OF THE INVENTION

The importance of wireless sensor networks (WSN) is shown in multiple applications, such as air pollution monitor, fire monitor, machine health monitor, area monitoring, and military applications. A wireless sensor network is comprised of a number of low-power network node devices with sensing and computing capability. The base stations are one or more distinguished components of the WSN with powerful computational, energy and communication resources. They act as a gateway between sensor nodes and the end user as they typically forward data from the WSN on to a server. The WSN is built of sensor “nodes”—from a few to several hundreds or even thousands, where each node is connected to one (or sometimes several) sensors. Each sensor node has typically several parts: a radio transceiver with an internal antenna or connection to an external antenna, a microcontroller, and electronic circuit for interfacing with the sensors. The power supply for the WSN nodes is usually a depletable power source, such as batteries. To increase the lifespan of sensor networks, a number of power management schemes have been designed. Many power management schemes take advantage of the energy saving features of sensor network hardware. Power management schemes need to control when a network sensor node should enter a high-power running mode and when to enter a low-power sleep mode. The power-down transition from high-power to low-power mode can usually be done with a set of instructions that shuts down hardware components, and the power management scheme may perform this action when certain conditions hold, e.g., there are no events in the system for a long time. The power-up transition from low-power to high-power mode is, however, a tricky problem because the network sensor node has its CPU halted and is unaware of the external events. In many applications, it is desirable to have the network awakened when some events of interest happen. But the sensor node cannot easily know exactly when events happen.

To solve this problem, many power management schemes require that each sensor node powers up periodically to listen to the radio channel. By choosing a good power-up/power-down schedule, the network may save much energy without compromising the system functionality. Examples include “Method and device for transponder aided wake-up of a low power radio device by a wake-up event,” U.S. Pat. No. 7,072,697 B2. In this patent, the implementation of the power-up/power-down scheduling often involves a timer that wakes up the microcontroller via an interrupt.

Another approach is to use a low-power stand-by hardware component to watch the environment when the node enters sleep mode. Some of examples are “Remote control wake up detector system,” U.S. Pat. No. 6,100,814, “Wake up device for communications system,” U.S. Pat. No. 7,912,442 B2, and “Method and device for transponder aided wake-up of a low power radio device by a wake-up event,” U.S. Pat. No. 7,072,697 B2. The system comprises means for switching the first communications device to and from sleep mode in response to receiving the wake up signal.

However, these systems previously have not addressed the method of increase the coverage of the power-up sequence. Also, the control of low-power wake-up device still needs extra power dissipation and additional complex control units.

In some WSN applications such as transportation or automotive, putting sensor nodes into long-time hibernation, or power-down mode, is more efficient to conserve power by shutting down the sensor nodes which are not used or active for a long time. Such scheme enables sensor nodes to have extremely low standby current (<1 uA), but the sensor nodes' power-up time become significant. Furthermore, if these applications require fast power-up time and wide power-up coverage at the same time, conventional power management schemes are hard to accomplish these design specifications.

### SUMMARY OF THE INVENTION

The present invention contrives to solve the disadvantages of the prior art.

An aspect of the invention provides a system for power management sequence for a wireless sensor network. The system comprises a base-station and a plurality of sensor nodes.

The base-station is for controlling the entire sensor nodes' data transmission and power management sequence.

The sensor nodes for providing sensing data to a base-station.

The base-station uses a type of multiplexing schemes for data and power-down message transmission.

The base-station broadcasts RF power-up messages to a plurality of sensor nodes.

The sensor nodes accept the power-up message and generate power-up detection signal, wherein during the power-up sequence a power-up detection circuitry uses energy from the RF power-up messages, and wherein the sensor nodes get ready to communicate with the base-station.

After the power-up sequence the sensor nodes start to propagate local power-up messages to neighbor nodes that are out of coverage from the base-station.

The base-station talks to the nodes in a sensor network to confirm that all the network nodes are waked up.

The sensor nodes may comprise an active RF radio, and wherein the active RF radio comprises an electronic circuitry, comprising:

a RF radio transceiver for wireless data transmission adapted to assign a single frequency channel;

an antenna adapted to receive a single frequency channel RF signals from base-stations or sensor nodes in a sensor network;

a power management unit adapted to provide regulated power supplies having multiple power/ground domains; and

a power-up receiver coupled to the antenna and adapted to dynamically sample RF signals for presence of the power-up receiver Enable (i.e. detection) signal, wherein the power-up receiver uses a same frequency with data transmission transceiver.

The power-up receiver for creating power-up signal to alert the transition to a power-up mode from a power-down mode may comprise:

the electronic switch adapted to couple the antenna when a sensor node is in the power-down mode, wherein the switch is off-state during data transmission, controlled by power-up receiver enable signal; and

a RF-to-DC converter adapted to convert the RF power-up messages into the DC power to drive a power-up receiver, wherein the rectifier is sometimes directly coupled to the antenna to enhance the RF sensitivity.

The power-up receiver may further comprise:

a RF amplifier adapted to boost the dynamic range of the RF power-up messages;

an RF envelope detector or rectifier adapted to convert the RF signals into the DC signal level; and

an comparator adapted to gain the DC signal level and drive it to the power-up management unit.

The power-up detector for generating a power-up detection signal to control the LDO and an electronic switch prior to a power-up receiver may comprise: a power-on-reset (PoR); two hysteresis input buffers; an exclusive-OR gate; and a D-type flip-flop.

The power-on-reset (PoR) in the power management unit may detect external power from a battery applied to the chip and generates a reset impulse that goes to the sensor node placing it into a known state.

Another aspect of the invention provides a method for power management sequence for a wireless sensor network including a base-station for controlling the entire sensor nodes' data transmission and power management sequence and a plurality of sensor nodes for providing sensing data to a base-station.

The method comprises steps for:

the base-station's broadcasting RF power-up messages to a plurality of sensor nodes;

on receiving the power-up message, the sensor nodes' using the energy from RF messages and making the sensor ICs power up to ready the data transmission;

the sensor nodes' starting to transmit the same power-up messages to neighbor nodes that are out of coverage from the base-station; and

the base-station's talking to the nodes in a sensor network to confirm that all the network nodes are waked up.

The type of multiplexing schemes may comprise TDD or FDD for data and power-down message transmission.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a diagram showing a topology of a proposed power-up sequence according to an embodiment of the present invention;

FIG. 2 is a diagram showing an exemplary block diagram of a sensor node according to an embodiment of the present invention;

FIG. 3 is a schematic diagram showing a power-down sequence according to an embodiment of the present invention;

FIG. 4 is a schematic diagram showing a power-up sequence according to an embodiment of the present invention;

FIG. 5 is a block diagram of a power management unit according to an embodiment of the present invention;

FIG. 6 is a timing diagram of a power management sequence of a sensor node according to an embodiment of the present invention;

FIG. 7 is a state diagram of a power management sequence according to an embodiment of the present invention; and

FIG. 8 is a flow chart showing a method for power management sequence according to another embodiment of the present invention.

### DETAILED DESCRIPTION EMBODIMENTS OF THE INVENTION

The Provisional U.S. Patent Application Ser. No. 61/521,412 is incorporated by reference into this disclosure as if fully set forth herein.

Method and device are disclosed for smart power management of the sensor nodes within a wireless sensor network to achieve extremely low standby current and fast power-up time. The proposed power management sequence features a technique of centralized remote power-up scheme combined with local broadcasting power-up sequence for entire sensor nodes. More importantly, RF power-up message from a base-station is using same frequency band as that of RF data communication, thus it is easier to implement a wireless switch. It can manage the power-down sequence from a base-station to sensor nodes sequentially, while the power-up sequence broadcasts its power-up message from the base-station to all the sensor nodes within a sensor network. When the network is opened, base-station broadcasts power-up message to all sensor nodes that are within its coverage. If one sensor node's receiving energy is low, neighbor sensor nodes that are within the centralized remote power-up coverage propagate local power-up message so as to complete the power-up sequence in a network. Each sensor node has a RF data transceiver and a power-up receiver, and they are separated with a RF power-up switch. The power-up receiver is able to generate self-powered power-up detection signal. It includes a RF-to-DC converter, a power-up switch, a RF gain amplifier, an RF envelope detector, and a comparator. The mode transition between data transmission and power-up/-down is controlled by the status of power-up switch, which is determined by a power-up detector at power management unit.

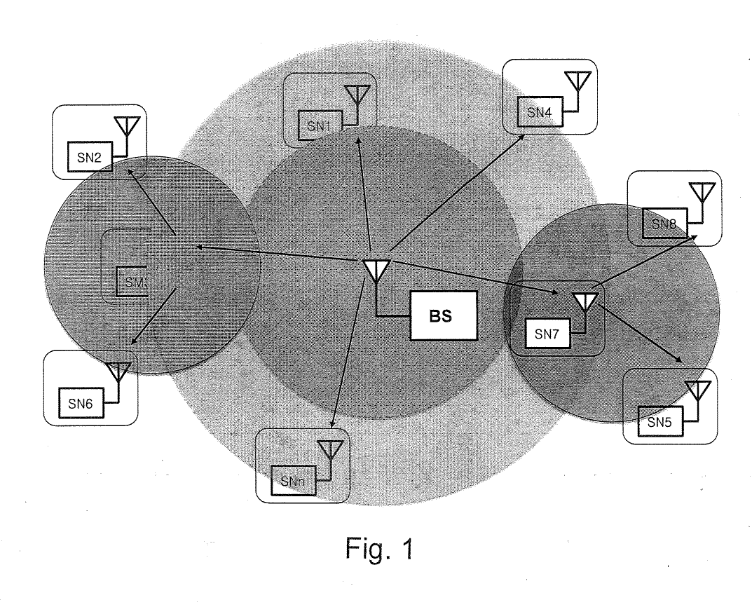

FIG. 1 demonstrates a conceptual topology of centralized remote power-up sequence combined with local broadcasting power-up sequence. The power management of the sensor network is controlled by a base-station. The base-station controls power-down sequence of each node with power-down message. However, it is not possible to control the node's power up sequence since there is no wireless link between base-station and nodes during power-down mode. When the network is opened, base-station broadcasts power-up message to all the sensor nodes with maximum output power level. Each node sends its initial information to base-station so as to acknowledge its power-up sequence. If one node's receiving energy is low, neighbor nodes receive the command to propagate local power-up message. In order to save the power-up time, another approach can be deployed: after detecting power-up transition, the nodes recover their power management unit, and get into “reset” state. And then, the nodes will enter the local power-up mode that the nodes remit power-up message locally. Since there is a specification of system power-up time, power-up sequence and its output power level have to be well optimized to meet this specification.

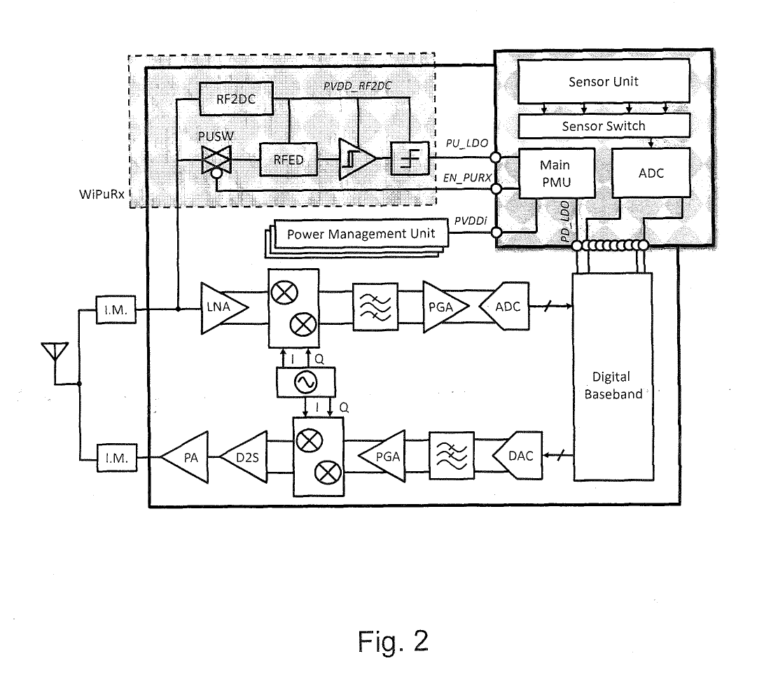

FIG. 2 shows an example block diagram of a sensor node that includes a radio transceiver and a sensor. The fully integrated radio consists of RF transceiver, LO synthesizer, data converters, and a digital baseband. The main transceiver is based on a low-IF receiver and a direct up-conversion transmitter. The single-ended LNA has two gain mode settings, and generates differential outputs. The differential downconverted signal by the double-balanced passive switched I/Q mixers is fed into the differential TIA. A complex band-pass filter incorporated with gain stages can adjust its bandwidth and baseband gain. The transmitter supports a direct up conversion transmit mode with an active-RC biquard filter. The driver amplifier (DA) has output power ranged from Po,min dBm to its maximum output power of Po,max dBm. The DA has a boosting output power mode for local power-up sequence. The quadrature LO signal is generated on-chip using a fractional-N frequency synthesizer operating at twice the LO frequency. The sensor IC contains four on-chip analog sensors, an analog multiplexer, and a high-resolution ADC. It also includes a main power management unit (PMU) to generate a regulated power supply from a single battery voltage from 2.7V to 4.8V.

The wireless power-up receiver (WiPuRx) is designed to generate self-powered power-up detection signal (PU_LDO) for main power management unit (PMU). It shares the same antenna with main transceiver to reduce the system overhead. The antenna is a printed PCB antenna, and is LC-matched to the average input impedance of the main receiver and the WiPuRx. Since RF signal frequency and power-up frequency are same at fRF, impedance matching network should be taken carefully. In receiver mode, PUSW is turned off, thus capacitance of RF2DC and high input impedance of WiPuRx will be added to that of main receiver. The matching network is designed so that its input impedance is 50□ at fRF. While the main receiver and transmitter are turned off in power-up mode, the on-board matching network incorporated with on-chip matching network is designed to make input impedance of 500 at fRF.

The WiPuRx has a RF-to-DC converter (RF2DC), similar to a passive transponder in an RFID system, to provide DC power (PVDD_RF2DC) to WiPuRx. The power-up detection circuit includes a power-up switch (PUSW), an RF envelope detector (RFED), and a comparator. The PUSW is placed in between antenna and WiPuRx to separate normal and power-up operation.

RF2DC generates DC power (PVDD_RF2DC) of power-up detection circuitry from incident RF power-up message. Power-up message consists of adjustable multiple packet lengths with no data contents. The PUSW is controlled by ‘EN_PURX’ generated from power management logic (PML) at main PMU (FIG. 2). Since the main PMU (including a main LDO) is shut downed, the power-down current is extremely low, less than 1 uA.

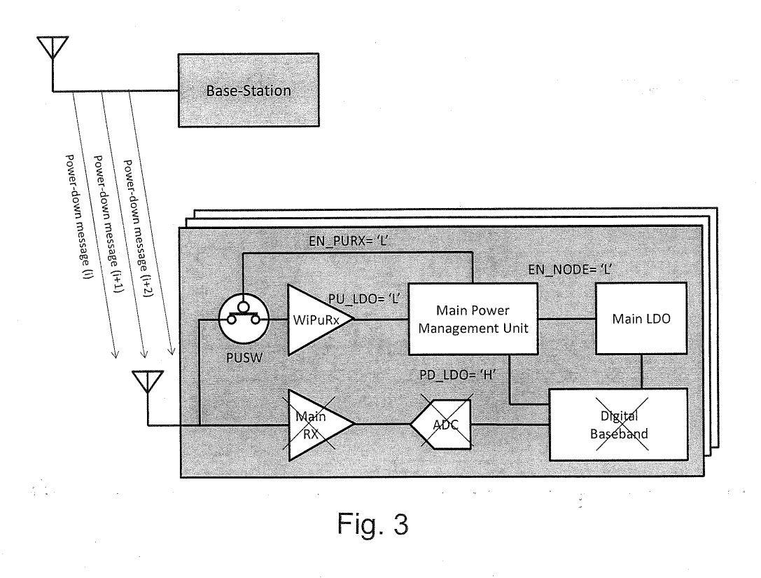

When a wireless sensor network is downed, base-station sends power-down message to all sensor nodes by either one at a time or broadcasting. Each node interprets the power-down message and makes main PMU shut downed. As EN_PURX=‘L’, the PUSW is closed and ready to detect power-up message (FIG. 3).

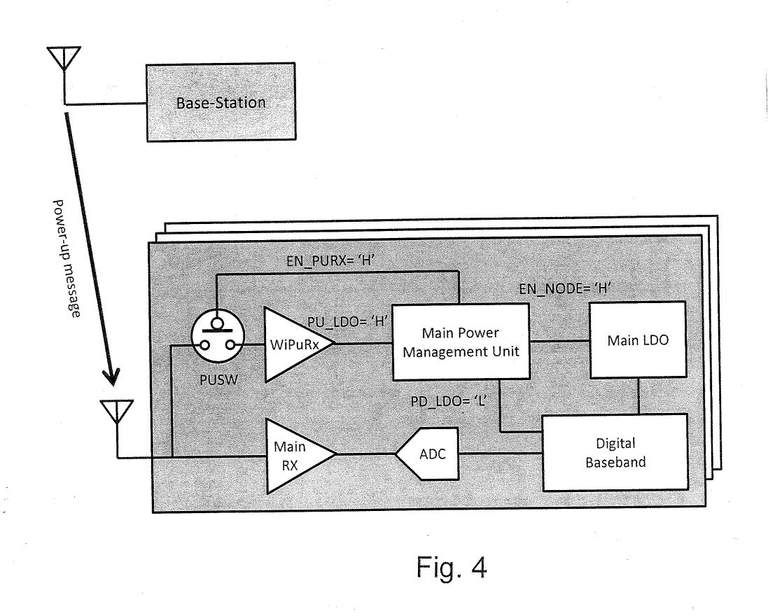

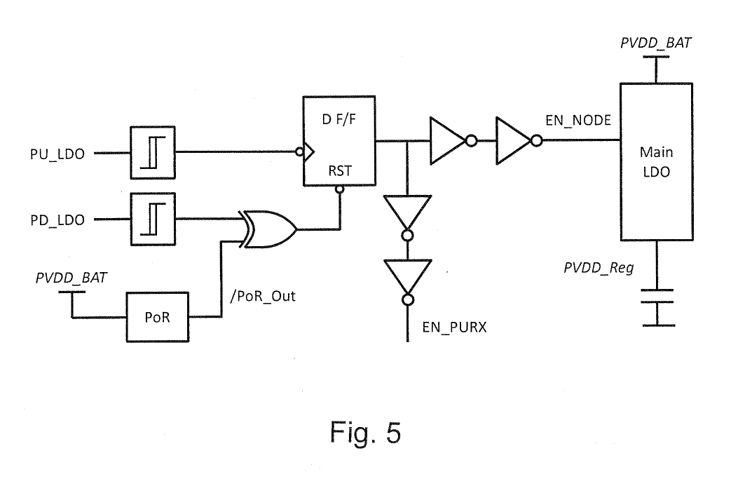

When network is opened, base-station broadcasts power-up message to all sensor nodes (FIG. 4). The power-up message at WiPuRx is (1) converted to D.C. power, PVDD_RF2DC, at RF2DC, and (2) to generate a power-up detection signal (PU_LDO). Actually, while PUSW is ‘on’ state, the power-up message is delivered to RFED. The single-ended RFED output is fed into a hysteresis buffer and a comparator to generate power-up detection signal, PU_LDO. The threshold voltage of the comparator is determined by the ratio of pull-up to pull-down device conductance. The signal ‘PU_LDO’ keeps ‘H’ state until power-down message is activated (‘PD_LDO’=‘H’). The main PMU generates ‘EN_LDO’ to activate the main LDO and to generate a regulated power supply from a battery voltage (FIG. 5). Then, the sensor nodes enter ‘Reset’ (or, Initial) state to ready the communication with a base-station. The local power-up sequence is initiated from ‘Reset’ state, and can be realized either two schemes. First one is based on power-up acknowledge message from sensor nodes to a base-station. Base-station configures the power-up status of the sensor node, and commands the nodes to propagate local power-up message to neighbor nodes. Second scheme is to propagate local power-up message from the nodes that are in ‘Reset’ state to neighboring nodes in order to reduce power-up time.

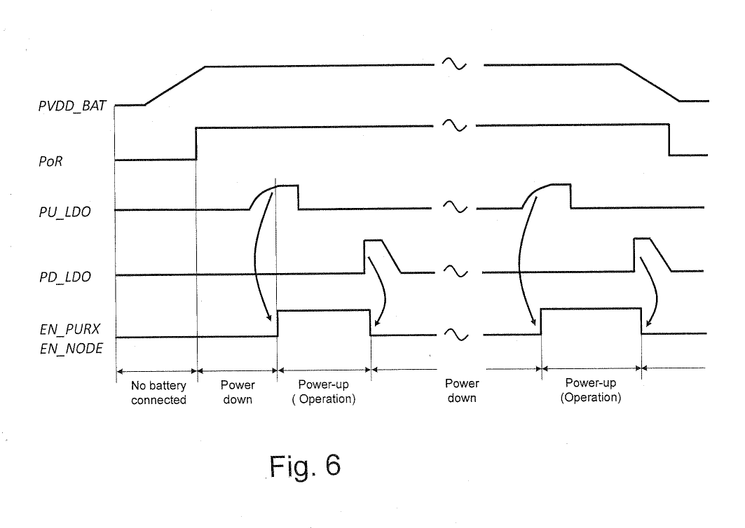

FIG. 6 depicts the timing diagram of power management sequence in a sensor node. The main power PVDD_BAT is powered up as a sensor IC is connected to a battery. Then, the power-on-reset (PoR) detects PVDD_BAT and generates a reset impulse that goes to the sensor node into a known state. Prior to power-up sequence, the node is in power-down mode. The power-up sequence starts with a power-up message from base-station, where a base-station broadcasts RF power-up message to unspecified node entities. The power-up message does not include any information such as node ID or operation commands, but only contains RF signal at fRF. Since PUSW is ‘on’ state (EN_PURX=‘L’) during power-down state, RF power-up message is rectified into DC power PVDD_RF2DC, and fed into WiPuRx. The WiPuRx generates a power-up detection signal (PU_LDO), and it triggers enable signal of the node (EN_NODE). It makes PUSW turn off, and pushes the sensor node into normal operation mode (actually reset state).

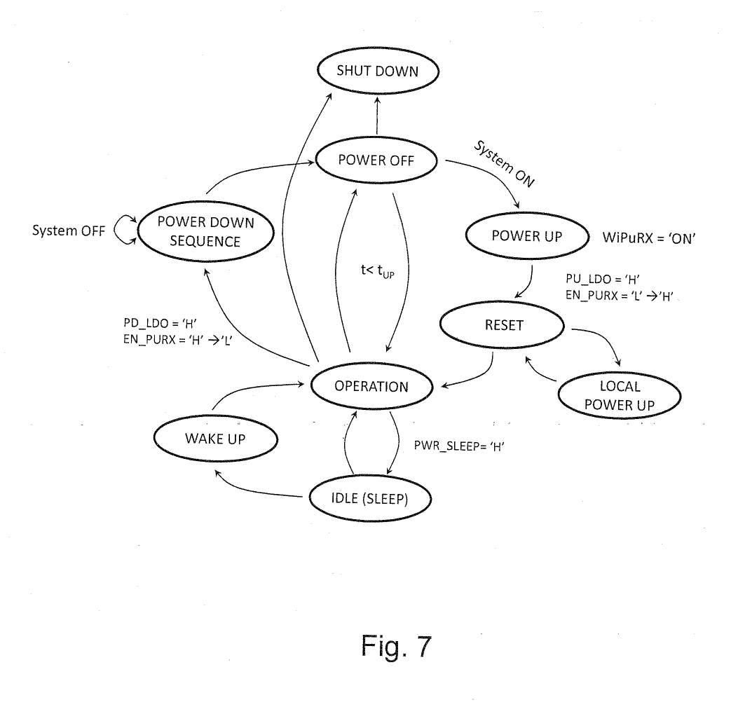

FIG. 7 is a state diagram of power-up sequence. The wireless sensor network is initially downed, and starts its operation by accepting ‘SYSTEM_ON’ signal from base-station. Then, sensor network starts to enter power-up sequence. During this sequence, wireless power-up receiver (WiPuRx) is on to create power-up detection signal (PU_LDO) from power-off state. Once power up sequence is completed, the sensor node enters ‘RESET” state and starts local power-up sequence. After completing power-up sequence, all the nodes get into operation mode. During operation mode, some (or, most of) sensor nodes can be pushed into the stand-by (or, idle) mode in order to satisfy the tight power budget. When the sensor network is about to be downed, or when reset signal is interrupted, the network starts its power-down sequence.

An aspect of the invention provides a power management sequence.

The base-station is for controlling the entire sensor nodes' data transmission and power management sequence.

The sensor nodes for providing sensing data to a base-station.

The base-station uses a type of multiplexing schemes for data and power-down message transmission.

The base-station broadcasts RF power-up messages to a plurality of sensor nodes.

The sensor nodes accept the power-up message and generate power-up detection signal, wherein during the power-up sequence a power-up detection circuitry uses energy from the RF power-up messages, and wherein the sensor nodes get ready to communicate with the base-station.

After the power-up sequence the sensor nodes start to propagate local power-up messages to neighbor nodes that are out of coverage from the base-station.

The base-station talks to the nodes in a sensor network to confirm that all the network nodes are waked up.

The sensor nodes may comprise an active RF radio, and wherein the active RF radio comprises an electronic circuitry, comprising:

a RF radio transceiver for wireless data transmission adapted to assign a single frequency channel;

an antenna adapted to receive a single frequency channel RF signals from base-stations or sensor nodes in a sensor network;

a power management unit adapted to provide regulated power supplies having multiple power/ground domains; and

a power-up receiver coupled to the antenna and adapted to dynamically sample RF signals for presence of the power-up receiver enable signal, wherein the power-up receiver uses a same frequency with data transmission transceiver.

The power-up receiver for creating power-up signal to alert the transition to a power-up mode from a power-down mode may comprise:

the electronic switch adapted to couple the antenna when a sensor node is in the power-down mode, wherein the switch is off-state during data transmission, controlled by power-up receiver enable signal; and

a RF-to-DC converter adapted to convert the RF power-up messages into the DC power to drive a power-up receiver, wherein the rectifier is sometimes directly coupled to the antenna to enhance the RF sensitivity.

The power-up receiver may further comprise:

a RF amplifier adapted to boost the dynamic range of the RF power-up messages;

an RF envelope detector or rectifier adapted to convert the RF signals into the DC signal level; and

an comparator adapted to gain the DC signal level and drive it to the power-up management unit.

The power-up detector for generating a power-up detection signal to control the LDO and an electronic switch prior to a power-up receiver may comprise: a power-on-reset (PoR); two hysteresis input buffers; an exclusive-OR gate; and a D-type flip-flop.

The power-on-reset (PoR) in the power management unit may detect external power from a battery applied to the chip and generates a reset impulse that goes to the sensor node placing it into a known state.

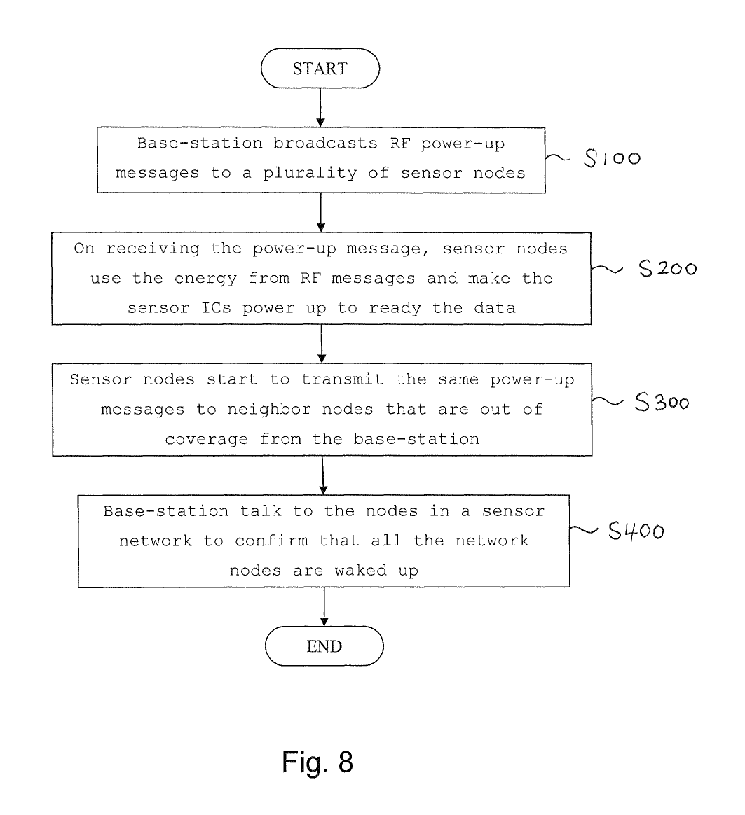

Another aspect of the present invention provides a method for power management sequence for a wireless sensor network including a base-station for controlling the entire sensor nodes' data transmission and power management sequence and a plurality of sensor nodes for providing sensing data to a base-station as shown in FIG. 8.

The method comprises steps for:

the base-station's broadcasting RF power-up messages to a plurality of sensor nodes (S100);

on receiving the power-up message, the sensor nodes' using the energy from RF messages and making the sensor ICs power up to ready the data transmission (S200);

the sensor nodes' starting to transmit the same power-up messages to neighbor nodes that are out of coverage from the base-station (S300); and

the base-station's talking to the nodes in a sensor network to confirm that all the network nodes are waked up (S400).

The distance-based broadcasting the power-up sequence activates sensor nodes that are within its coverage. And then, for the out-of-range nodes, the power-up sensor nodes remit the power-up sequence to their neighbor sensor nodes so as to complete the power-up sequence of a sensor network.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A system for power management sequence for a wireless sensor network, comprising:
a base-station for controlling the entire sensor nodes' data transmission and power management sequence; and
a plurality of sensor nodes for providing sensing data to a base-station,
wherein the base-station uses a type of multiplexing schemes for data and power-down message transmission,
wherein the base-station broadcasts RF power-up messages to a plurality of sensor nodes,
wherein the sensor nodes accept the power-up message and generate power-up detection signal, wherein during the power-up sequence a power-up detection circuitry uses energy from the RF power-up messages, and wherein the sensor nodes get ready to communicate with the base-station,
wherein after the power-up sequence the sensor nodes start to propagate local power-up messages to neighbor nodes that are out of coverage from the base-station, and
wherein the base-station talks to the nodes in a sensor network to confirm that all the network nodes are waked up.

2. The system of claim 1, wherein the sensor nodes comprises an active RF radio, and wherein the active RF radio comprises an electronic circuitry, comprising:
a RF radio transceiver for wireless data transmission adapted to assign a single frequency channel;
an antenna adapted to receive a single frequency channel RF signals from base-stations or sensor nodes in a sensor network;
a power management unit adapted to provide regulated power supplies having multiple power/ground domains; and
a power-up receiver coupled to the antenna and adapted to dynamically sample RF signals for presence of the power-up receiver enable signal, wherein the power-up receiver uses a same frequency with data transmission transceiver.

3. The system of claim 2, wherein the power-up receiver for creating power-up enable signal to alert the transition to a power-up mode from a power-down mode comprises;
an electronic switch adapted to couple the antenna when a sensor node is in the power-down mode, wherein the switch is off-state during data transmission, controlled by power-up receiver enable signal; and
a RF-to-DC converter adapted to convert the RF power-up messages into the DC power to drive a power-up receiver, wherein the rectifier is sometimes directly coupled to the antenna to enhance the RF sensitivity.

4. The system of claim 3, wherein the power-up receiver further comprises:
a RF amplifier adapted to boost the dynamic range of the RF power-up messages;
an RF envelope detector or rectifier adapted to convert the RF signals into the DC signal level; and
an comparator adapted to gain the DC signal level and drive it to the power-up management unit.

5. The system of claim 4, wherein the power-up detector for generating a power-up detection signal to control the LDO and an electronic switch prior to a power-up receiver comprises:
a power-on-reset (PoR);
two hysteresis input buffers;
an exclusive-OR gate; and
a D-type flip-flop.

6. The system of claim 5, wherein the power-on-reset (PoR) in the power management unit detects external power from a battery applied to the sensor node and generates a reset impulse that goes to the sensor node placing it into a known state.

7. The system of claim 1, wherein the local broadcasting power-up message generates from power-up sensor nodes to neighbor nodes automatically, and wherein otherwise the base-station receives the confirmation of power-up from the nodes, and then command the nodes to propagate power-up message to neighbor nodes.

8. The system of claim 1, wherein the type of multiplexing schemes comprises TDD or FDD for data and power-down message transmission.

9. A method for power management sequence for a wireless sensor network including a base-station for controlling the entire sensor nodes' data transmission and power management sequence and a plurality of sensor nodes for providing sensing data to a base-station, the method comprising steps for:
the base-station's broadcasting RF power-up messages to a plurality of sensor nodes;
on receiving the power-up message, the sensor nodes' using the energy from RF messages and making the sensor ICs power up to ready the data transmission;
the sensor nodes' starting to transmit the same power-up messages to neighbor nodes that are out of coverage from the base-station; and
the base-station's talking to the nodes in a sensor network to confirm that all the network nodes are waked up.
